(19) United States
(12) Patent Application Publication
(10) Pub. No.: US 2005/0003205 A1
(43) Pub. Date: Jan. 6, 2005

(54) Mildew-resistant sealing compound formulations containing a benzothiophene-2-cy-clohexylcarboxamide-s,s-dioxide

(76) Inventors: Peter Wachtler, Krefeld (DE); Markus Alexander Putzer, Leverkusen (DE); Thomas Augustin, Koln (DE); Krystyna Preuss, Leverkusen (DE)

Correspondence Address: Norris McLaughlin & Marcus, 30th Floor, 220 East 42nd Street, New York, NY, 10017, US

(21) Appl. No.: 10/483,357

(22) PCT Filed: Jul. 3, 2002
(86) PCT No.: PCT/EP02/07320

(30) Foreign Application Priority Data
Jul. 11, 2001 (DE) 101 33 545.8

(51) Int. Cl. B32B 27/40; B32B 27/00; B32B 27/30; C08K 5/36

(52) U.S. Cl. 428/423.1; 428/447; 428/523; 523/122

(57) ABSTRACT

The invention relates to mildew-resistant sealing compounds, in particular with a base of silicone, urethane and/or an acrylic base, which contain a benzothiophene-2-cyclohexylcarboxamide-S,S-dioxide.

The invention relates to the application of benzothiophene-2-cyclohexylcarboxamide-S,S-dioxide in sealing compounds (sealants), in particular in silicone compounds for the production of mildew resistant sealants, in particular of single-component silicone rubber compounds, which cure neutrally at room temperature.

Sealing compounds, such as those on the basis of silicone, are often afflicted with mildew, which is able to utilize the decomposition of the sealant, for example the decomposition of by-products contained within them, or the absorbed residue, such as alcohols or organic acids, for its own metabolism. The probability of affliction with mildew is particularly high if, for example, silicone rubber compounds are exposed to increased humidity, such as occurs, for instance, in sanitary areas. Here, mildew can cause an unsightly, discolored, and unsanitary surface of the sealing compounds. In particular, single-component silicone rubber compounds, hereinafter referred to as RTV-1K compounds, are affected, because they embody the sealing compound type most commonly used in sanitary areas. The fungicides utilizable in RTV-1K compounds are extremely limited, because only few meet all requirements of this type of application. In accordance with ISO 846, for example, the fungicidal effect of a material can be tested for penicillium funicolosum, chaetomium globosum, paecilomyces variotii, aspergillus niger, and gliocladium virens. The list of fungi must be expanded, if other types of fungi are relevant in any specific application. Despite the desired toxicity of fungicides versus mildew, the toxic effect on the human organism should be as low as possible. The solubility in water should be low in order to avoid premature elution of the active species from the sealing compound matrix. Furthermore, the active species must be compatible with the uncured sealing compound, such as the RTV-1K compound, in order to ensure a fungicide effectiveness even after longer periods of storage of the silicone rubber compounds. The fungicide used should not affect the curing properties, the adhesion on certain substrates, or the color of the sealing compound. Particularly in transparent and only slightly colored versions, discolorations of the RTV-1K compounds are observed when fungicides are added. Discolorations that are caused by fungicides particularly occur in neutrally cured RTV-1K sealing compounds. Neutral systems can be constructed on the basis of oxime curing agents (examples contained in EP-A-0 118 030 and EP-A-0 316 591), benzamide curing agents (examples contained in EP-A-0 553 143) and of alkoxy curing agents (examples contained in DE-A-195 49 425, U.S. Pat. No. 4,417,042, and EP-A-0 327 847).

Fungicides used in sealing compounds are comprised of diverse chemical compound classifications. Examples are:
1.) N-(fluordichloridemethylthio)phthalimide (trade names: Fluor-Folper, Preventol A3).
2.) Methyl-benzimideazol-2-ylcarbamate (trade names: Carbendazim, Preventol BCM)
3.) 10,10′-oxy-bisphenoxarsine (trade name: Vinyzene, OBPA)
4.) Zinc-bis(2-pyridylthio-1-oxide) (zinc pyrithion)
5.) 2-(4-thiazolyl)-benzimidazol
6.) N-phenyl-iodpropargylcarbamate
7.) N-octyl-4-isothiazolin-3-on
8.) 4,5-dichloride-2-n-octyl-4-isothiazolin-3-on
9.) N-butyl-1,2-benzisothiazolin-3-on
10.) Triazolyl-compounds, such as tebuconazol in combination with zeolithes containing silver (EP 931 811 and EP 640 661)

These fungicides can be used in silicone rubber compounds under certain conditions, but their usability is limited. BCM shows no satisfactory effect on alternaria alternata, a type of fungus that is often found, for example, in residential sanitary areas. OBPA has the tendency to be eluted relatively quickly,and must therefore be classified as one of the metal-organic compounds containing arsenic due to its chemical composition, which raises the question of ecological compatibility. Zinc pyrithion causes a discoloration of the cured sealing compound if the sealant is allowed to contact iron ions in tap water. Fluor-Folpet is not satisfactorily effective on trichoderma viride, and causes strong discolorations in the above named neutrally cured RTV-1K compounds, or even leads to curing failures. Such a chemical incompatibility is also found in the fungicides of the above list, which have not yet been discussed. The additional use of zeolithes containing silver ions leads to limitations in coloring and is high in costs.

The use of other highly effective, new fungicides in material protection is often impossible at this time due to ethical reservations, such as the exclusive use for human medicine, or the necessary effectiveness concentration in the matrix is economically of no interest.

The invention is based on the task of providing an economically usable fungicide, which can be used in sealing compounds, for example in neutrally curing silicone sealing compound formulations, for the protections against a broad array of fungi, especially also alternaria alternata, which does not have the previously named disadvantages, which is not prematurely eluted, and which is chemically compatible with the formulations.

Surprisingly, it was found that the fungicide benzothiopene-2-cyclohexylcarboxamide-S,S-dioxide, hereinafter referred to as Preventol VP OC 3061, can be used in sealing compound formulations. Preventol VP OC 3061 is used preferably in sealing compounds on silicon basis, urethane basis, and/or acrylic basis.

The subject of the invention is therefore sealing compounds containing benzothiophene-2-cyclohexyl-carboxamide-S,S-dioxide, which do not have the disadvantages of prior fungicides with regard to coloration, broadness of effectiveness spectrum, especially alternaria alternata, as well as the limited shelf life of these sealing compound formulations before application.

If Preventol VP OC 3061 is worked into silicon, urethane, or acrylic sealing compounds, cured sealing compound test plates (“sheets”), both in the fresh condition and after rinsing, i.e. repeated contact with water, show a good fungicidal effect on all types of fungi tested in accordance with ISO 846 (penicillium funicolosum, chaetomium globosum, paecilomyces variotii, aspergillus niger, and gliocladium virens). An important advantage of using Preventol VP OC 3061 in sealing compounds is its effectiveness on alternaria alternata, a fungus not listed in ISO 846, but which is found particularly in rooms with high humidity. Preventol VP OC 3061 does not cause any discolorations or affect the shelf life in these sealing compounds. The mechanical properties of these sealing compounds are also not affected.

Preventol VP OC 3061 and its production are described in EP-A-0 512 349 of Bayer AG. Special applications in latex paint, i.e. coating materials, or in pest management have been described in DE-A-43 28 074, as well as in EP-A-0 512 349. However, they contain no reference to the possibility of use in sealing compounds, and the conditions to be selected for the effective utilization particularly against alternaria alternata.

According to the invention, all common sealing compounds can be made mildew-resistant in the uncured condition, or under 60° C. These are preferably sealing compounds on silicon, urethane, or acrylic basis, or compounds thereof. Examples for silicone sealing compounds are named in the previously cited patents, such as EP-A-0 118 030, EP-A-0 316 591, EP-A-0 327 847, EP-A-0 553 143, DE-A-195 49 425, and U.S. Pat. No. 4,417,042, as well as in Ullmann's Encyclopedia of Industrial Chemistry, sixth Ed. 2001 Electronic Release chapter 5, R. D. Grant: Silicone Sealants In The Polymeric Materials Encyclopedia 1996 CRC Press, Inc., Urethane Sealing Compounds in Ullmann's Encyclopedia of Industrial Chemistry, sixth Ed. 2001 Electronic Release chapter 4, as well as in J. R. Panek and J. P. Cook: Construction Sealants and Adhesives 3^{rd} Ed. J. Wiley & Sons 1991 New York p. 129-138, as well as in U.S. Pat. No. 5,077,360.

Sealing compounds are to be understood as materials in accordance with DIN EN 26 927, which, unlike coating materials are applied in thicker layers than the same, and therefore have a different vaporization behavior of their components during the curing process. Sealing components are also to be understood particularly as those sealing compounds that plastically or elastically cure (into elastomers) as sealants. Elastomers are defined in DIN 7724 in accordance with the Römpp Chemical Dictionary. For these sealing compounds that are highly ductile due to their elastomeric properties, the protection of their changeable surface is a particular challenge. Examples for acrylic sealing compounds are found in J. R. Panek and J. P. Cook: Construction Sealants and Adhesives 3^{rd} Ed. J. Wiley & Sons 1991 New York p. 159-175, as well as WO 01-09249, or U.S. Pat. No. 5,077,360.

These are preferably systems that cure at room temperature, such as published in U.S. Pat. No. 5,077,360, or EP-A-0 327 847.

These may also be multiple-component systems, in which the catalyst and the curing agent may be present separately, such as in U.S. Pat. No. 4,891,400, U.S. Pat. No. 5,502,144, or other so-called silicone RTV 2K systems, particularly platinum-free systems.

However, single-component systems are preferred. These are systems, such as described in J. R. Panek and J. P. Cook, see above, p. 168 and following, and Ullmann's Encyclopedia of Industrial Chemistry, sixth Ed. 2001 Electronic Release chapter 5, which contain all components necessary for the construction of a sealing compound in their storable condition under the exclusion of humidity or oxygen., and which cure after exposure to ambient air, after they have been transported to the site of application, for example by means of extrusion.

Particularly preferred are so-called silicone neutral systems, namely DE-A-195 49 425, U.S. Pat. No. 4,417,042, or EP-A-0 327 847, in which the conversion of curing agents with the moisture of the ambient air does not lead to corrosive acidic, alkaline, or odor-intensive decomposition products.

These systems have been described, for example, in the previously mentioned bibliography locations. The task of effectively protecting silicone rubber systems from all types of fungi is diverse indeed, because each system is cured with typical silane curing agents, and therefore has additional typical ingredients.

Additionally introduced active agents should therefore neither with the not yet cured mass (shelf form), nor with the mass provided for curing, undergo any such interactions that their intended application is impeded.

The sealing compound systems may contain all additives typical for the individual sealing compounds, such as the typical thickening agents, reinforcing fillers, curing agents, curing catalysts, pigments, adhesives, or other volume extenders.

Preferred formulations for the application of the fungicides according to the invention are the compounds described in the examples. Any limitations regarding the effectiveness in the fungicides according to the invention may result from common reactions between the fungicide and the curing agents, or catalysts, as well as from extreme pH or temperature conditions. Other limitations represent the interactive solubilities between the fungicide and the sealing compound.

Preventol VP OC 3061 can be worked into the uncured sealing compounds at any time. This is done, for example, by means of dispersing, such as after the use of common dispersing units, such as ball mills, or high-capacity mixers, such as kneaders, planetary mixers, under the exclusion of humidity and oxygen. Base compounds can be produced in part of the sealing compounds, or in one or several components, or part thereof. For this purpose, common auxiliary agents may be used, for example substrates, such as hydrophobic silica, or other silicates. Preventol is present as a solid, which can be dispersed easier and faster with the aid of the inorganic substrates.

But treatments of cured, hardened surfaces are also included, in that solutions of Preventol are applied that transport the active agent into the matrix by means of diffusion, or swelling, respectively. The solution remains present more or less completely. The amount of Preventol VP OC 3061 added can be easily determined by the person skilled in the task depending on the range of application and composition of the sealing compounds. For example, it may be at 0.15-6.0 weight-%, in this case preferably at 0.5 to 3.0 weight-% based on the finished composition.

If necessary, Preventol VP OC 3061 may also be used in combination with other active agents, such as in a compound containing additional fungicides, acaricides, or insecticides.

Surprisingly, it was shown that, according to experience, despite the mostly limited possibilities of application of suitable fungicides for curable sealing compounds, with Preventol VP OC 3061 both yellowing-free masses may be provided, which offer a high degree of protection against a broad spectrum of fungi, as well as masses that can be stored and cured at the desired time.

The following examples serve to explain the invention, but are not limiting.

### EXAMPLE 1

A fungicide base compound was produced by means of even dispersing of 500 weight-parts of benzothiophene-2-cyclohexylcarboxamide-S,S-dioxide with 60 weight-parts of hydrophobic silica (Degussa-Hüls, trade name “Aerosil® R972”) in 1440 weight-parts of an ahpha,omega-trimethyl-terminated polydimethylsiloxane, which was characterized by its viscosity of 20 mPa.s at 25° C. with the aid of a ball mill.

### EXAMPLE 2

This example describes the production of a fungicidal, neutrally curing RTV-1K sealing compound on the basis of an alkoxy curing agent.

55.4 weight-parts of an ahpha,omega-hydroxyl-terminated polydimethylsiloxane, which was characterized by a viscosity of 80 Pa.s at 25° C., and a shear rate gradient of D=1 s⁻¹, were mixed with 28.4 weight-parts of an ahpha,omega-trimethyl-terminated polydimethylsiloxane with a viscosity of 100 mPa.s (25° C. D=1 s⁻¹) in a planetary mixer. All ingredients, as well as the mass itself, were protected from humidity. 0.25 weight-parts of mono-2-ethylhexylphosphoric acid ester, 0.2 weight-parts of methanol, and 2.94 weight-parts of vinyltrimethoxysilane (VTMS) were added successively. After ten minutes, 10.3 weight-parts of silica hydrophobic silica, which is available by Degussa-Hüls under the name of Aerosil® R 972, were added successively. After the dispersion of the silica homogenous under vacuum, 1.0, or 1.5 weight-parts of the fungicide base compound from example 1, 1.37 weight-parts of an ahpha,omega-(diethoxy-3-propylamine)-terminated dodecamethylmethylhexasiloxane, and 0.39 weight-parts of a solution from 45% dioctylzinnoxide in tetrapropylsilicate were added and stirred at a high degree of rotation in the mixer. A colorless, transparent RTV-1K mass with a long shelf life was obtained, which was quickly filled into cartridges, and quickly sealed in order to protect it from humidity.

Samples of this formulation were filled into aluminum tubes, hermetically sealed, and stored at 50° C. in order to accelerate aging. After two weeks of storage, the tubes were cooled down to room temperature, and 2 mm thick test plates (“sheets”) were constructed from the sealing compounds. The pastes were still transparent, and showed a normal curing behavior. In a test series, the fungicidal effect of the cured elastomers was confirmed. The results of these tests, which were also tested for alternaria alternata in addition to the types of fungi prescribed by ISO 846, are compiled in table 1. The alkoxy elastomers with Preventol VP OC 3061 show a good fungicidal effect on all types of fungi tested (including alternaria alternata) both in their fresh condition and after rinsing, i.e. in the rinsing behavior after simulated contact with water.

### EXAMPLE 3

This example describes the production of a fungicide, cured RTV-1K sealing compound on the basis of an acetoxy curing agent. 56 weight-parts of an ahpha,omega-hydroxyl-terminated polydimethylsiloxane, which is characterized by a viscosity of 80 Pa.s at 25° C., were mixed with 30 weight-parts of an ahpha,omega-trimethyl-terminated polydimethylsiloxane with a viscosity of 100 mPa.s at 25° C. in a planetary mixer. All ingredients, as well as the mass itself, were protected from humidity. 3.7 weight-parts of ethyltriacetoxysilane and 0.4 weight-parts of di-ter-butoxy-diacetoxysilane were stirred in successively. After ten minutes, 9.5 weight-parts of hydrophilic silica, which is available from Degussa-Hüls under the name of Aerosil® 150, were added successively. After the silica was homogenously dispersed under vacuum, 0.0 or 1.0 weight-parts of the fungicide base compound from example 1 and 0.01 weight-parts of dibutylstannousdiacetate were added and stirred at a high degree of rotation by mixer. A colorless, transparent RTV-1K mass with a long shelf life was obtained, which was quickly filled into cartridges, and which was quickly sealed in order to protect it from humidity.

In these elastomers cured with the so-called acetoxy curing agent, Preventol VP OC 3061 has a lower fungicidal effect on the entirety of all types of fungi tested than in example 2, both in their fresh condition and after rinsing.

The following describes the test method used to determine the fungicidal effect of the sealing compound test plates: one half each of a sealing compound “sheet” was rinsed under running water (120 hrs, 20° C. average speed: 12 l/hr). From the untreated and the rinsed test plates, round test bodies are produced with a diameter of 3 cm. These test samples were placed in sterile Petri dishes with liquid malt extract agar, which was previously contaminated with the test fungi, and they were layered so that the agar layer over the test sample remained as thin as possible (approximately 1 mm).

The test was performed as a double determination test. The storage temperature was 26° C. at an incubation time of 2-3 weeks. Subsequently, the test was evaluated visually according to the evaluation diagram listed in table 2 below.

TABLE 1
Effectiveness Tests of Preventol VP OC 3061 in the Alkoxy System
(evaluated after mixing of the sealing compound within 2 weeks)

| | Degree | Evaluation of compound | Evaluation of |
|---|---|---|---|
| Sample description¹⁾ | of growth²⁾: | Incolulum³⁾: | alternaria alternata: |
| 1.0% F | 2 | 3 cm zone of inhibition visible, | edge growth |
| | | but no germ growing up to the | |
| | | edge of the test sample | |
| 1.0% F, rinsed | 2 | 3 cm zone of inhibition visible, | edge growth |
| | | but no germ growing up to the | |
| | | edge of the test sample | |
| 1.5% F | 2 | 4 cm zone of inhibition visible, | edge growth |
| | | but no germ growing up to the | |
| | | edge of the test sample | |
| 1.5% F, rinsed | I-2 | 4 cm zone of inhibition visible, | 4 mm zone of inhibition |
| | | but no germ growing up to the | |
| | | edge of the test sample | |

¹⁾F stands for fungicide base compound from example 1 with Preventol VP OC 3061.
²⁾The classification of the degree of growth is broken down in table 3.
³⁾The composition of the compound inoculum is described in table 4.

TABLE 2
Effectiveness Tests of Preventol VP OC 3061
in the Acetoxy System of Example 3

| | Degree of growth²⁾ of the |
|---|---|
| Sample description¹⁾ | Compound inoculum³⁾: |
| 0.0% F | 0 |
| 0.0% F, rinsed | 0 |
| 1.0% F | 1 |
| 1.0% F, rinsed | 1 |

¹⁾F stands for fungicide base compound from example 1 with Preventol VP OC 3061.
²⁾The classification of the degree of growth is broken down in table 3.
³⁾The composition of the compound inoculum is described in table 4.

TABLE 3
Evaluation Diagram of the Degree of Growth

| Degree of | |
|---|---|
| Growth: | Appearance of test material: |
| 0 | Inadequate mildew resistance |
| | The test sample shows >10% of growth of the test |
| | organisms. |
| 1 | Moderate mildew resistance |
| | The test sample shows a maximum growth of 10% |
| | of the test organisms. |
| 2 | Good mildew resistance |
| | The test sample shows not growth of test organisms, |
| | or shows only a slight growth at the edges; there is no |
| | growth-free zone (zone of inhibition) around the test sample. |
| 3 | (Very) good mildew resistance |
| | The test sample shows no growth of test organisms; |
| | there is a growth-free zone (zone of inhibition) |
| | around the test sample. |

Explanation: A sealing compound sheet is mildew resistant, if it shows an even appearance/equally large zone of inhibition before and after artificial aging/lixiviation with running water, i.e. if it can be assessed at 2 or 3 before an after aging.

TABLE 4
Composition of the Compound Inoculum and the Single Germ

| | | Seed culture (germs/ml |
|---|---|---|
| | Mildew fungi: | Agar): |
| Compound inoculum: | Pencillium funicolosum | 5.2-10⁴ |
| | Chaetomium globosum | 2.9-10⁴ |
| | Paecilomyces variotii | 3.6-10⁴ |
| | Aspergillus niger | 1.7-10⁴ |
| | Glicocladium virens | 4.6-10⁴ |
| Single germ: | Alternaria alternata | 1.0-10⁴ |

### EXAMPLE 4

### Comparison

Silicone rubber compounds are produced according to example 2, to which however, instead of 1.0 or 1.5 weight parts of the fungicide base compound from example 1, 0.5 or 1.0 weight-parts of the fungicide 10,10′-oxy-bisphenoxarsine were added. Samples of this formulation were filled into aluminum tubes; they were hermetically sealed, and stored at 50° C. as in example 2. After two weeks, the masses were strongly discolored.

According to example 2 or 3, the fungicidal effectiveness of the resulting sealing compound was determined in table 5.

TABLE 5
Effectiveness Tests of 10,10′-oxy-bisphenoxarsine in the Alkoxy System

| | | | Evaluation of |
|---|---|---|---|
| | Degree | Evaluation of compound | alternaria alternata: |
| Sample description¹⁾ | of growth²⁾: | Incolulum³⁾: sample 1/sample 2 | sample 1/sample 2 |
| 0.5% F | 3 | 5 cm zone of inhibition/4-5 cm | 1 cm zone of inhibition/ |
| | | zone of inhibition | 1 cm zone of inhibition |
| 0.5% F, rinsed | 3 | 2 cm zone of inhibition/1-2 cm | Minimal edge growth |
| | | zone of inhibition | |
| 1.0% F | 3 | 3-4 cm zone of inhibition/3-4 cm | 1.5 cm zone of inhibition/ |
| | | zone of inhibition | 1-2 cm zone of inhibition |
| 1.0% F, rinsed | 3 | 5 cm zone of inhibition/4-5 cm | Minimal edge growth |
| | | zone of inhibition | |

¹⁾F stands for fungicide 10,10′-oxy-bisphenoxarsine.
²⁾The classification of the degree of growth is broken down in table 3.
³⁾The composition of the compound inoculum is described in table 4.

### EXAMPLE 5

### Comparison

Silicone rubber compounds are produced according to examples 2 and 3, to which, however instead of 1.0 or 1.5 weight-parts of the fungicide base compound from example 1, no fungicide was added.

Samples of this formulation were filled into aluminum tubes, hermetically sealed, and stored for 2 weeks at 50° C., as in example 2. The pastes were transparent and showed a normal curing behavior.

The results in the effectiveness tests, which were performed as in example 2, are shown in the following table 6.

TABLE 6
Effectiveness Tests in Pure Alkoxy or Acetate Systems
(without fungicide) of Examples 2 and 3

| | | Evaluation of | Evaluation |
|---|---|---|---|
| | Degree of | compound | of alternaria |
| Sample description | growth¹⁾: | Incolulum²⁾: | alternata: |
| Alkoxy example 2 | 0 | complete growth | complete growth |
| Alkoxy, example 2 | 0 | complete growth | complete growth |
| Rinsed | | | |
| Acetate example 3 | 0 | complete growth | complete growth |
| Acetate example 3, | 0 | complete growth | complete growth |
| Rinsed | | | |

¹⁾The classification of the degree of growth is broken down in table 3.
²⁾The composition of the compound inoculum is described in table 4.

### EXAMPLE 6

### Comparison

Silicone rubber compounds were produced according to example 2, to which, however instead of 1.0 or 1.5 weight-parts of the fungicide base compound from example 1, 0.5 or 1.0 weight-parts of a fungicide base compound (1:1 weight-parts) of N-(dichloridefluormethylthio)phthalimide (trade name: Fluor-Folpet) and methylbenzimidozol-2-ylcarbamate (trade name: Carbendazim, BCM) were added.

Samples of this formulation were filled into aluminum tubes, as in example 2, hermetically sealed and stored at 50° C. After two weeks test plates (sheets) stored at the normal climate (determined by ISO 11600: 23±1° C., 50±5% relative humidity) of 2 mm thickness showed no hardening.

### EXAMPLE 7

In a planetary mixer, 99 weight-parts of the acrylate sealing compound “Bifa Acrylic, rapid, rain-resistant,” which was obtained from Kunststoff Technologie GmbH & Co. KG, were mixed with 1.0 weight-parts of the fungicide base compound from example 1, and stirred under the exclusion of humidity.

Samples of this formulation were filled into aluminum tubes; these were hermetically sealed, and stored for 2 weeks at 50° C., as in example 2. The pastes were still pure white, and showed a normal hardening behavior.

The fungicidal effectiveness of the resulting sealing compound was determined according to example 2.

TABLE 7
Effectiveness Test of VP OC 3061 in the
Acrylic Sealing Compound System

| Description | | Evaluation of compound |
|---|---|---|
| of sample¹⁾ | Degree of growth²⁾: | inoculum³⁾: sample 1/sample 2 |
| 1.0% F | 2 | Zone of inhibition/zone of |
| | | inhibition |

¹⁾F stands for fungicide base compound from example 1 with Preventol VP OC 3061.
²⁾The classification of the degree of growth is broken down in table 3.
³⁾The composition of the compound inoculum is described in table 4.

### EXAMPLE 8

### Comparison

Acrylic rubber compounds were produced according to sample 7, in which, however instead of 1.0 weight-parts of the fungicide base compound from example 1, no fungicide was added.

Samples of this formulation were filled into aluminum tubes; these were hermetically sealed and stored for 2 weeks at 50° C., as in example 2. The pastes were opaque white, and showed a normal hardening behavior. Table 8: Effectiveness tests in the pure acrylic sealing compound system.

TABLE 8
Effectiveness Tests of VP OC 3061 in the Acrylic
Sealing Compound System

| | | Evaluation of compound |
|---|---|---|
| Description of sample | Degree of growth¹⁾: | inoculum²⁾: |
| Acrylic Bifa | 0 | Complete growth |
| Acrylic Bifa, | 0 | Complete growth |
| Rinsed | | |

¹⁾The classification of the degree of growth is broken down in table 3.
²⁾The composition of the compound inoculum is described in table 4.

1. Sealing compounds containing benzothiophene-2-cyclohexylcarboxamide-S,S-dioxide.

2. Sealing compounds according to claim 1, wherein said sealing compounds are systems which are curable at room temperature.

3. Sealing compounds according to claims 1 or 2, wherein said sealing compounds are single-component systems.

4. Sealing compounds according to claims claims 1 or 2, wherein said sealing compounds are silicone, urethane, and/or acrylic sealing compounds.

5. A method of rendering sealing compounds mildew-resistant, which comprises adding benzothiophene-2-cyclohexylcarboxamide-S,S-dioxide to said sealing compounds in quantities of 0.25-3 weight-%.

6. Method for the protection of cured sealing compounds from mildew, which comprises curing or treating said sealing compounds with benzothiophene-2-cyclohexylcarboxamide-S,S-dioxide.

7. Articles, shaped articles, or coatings containing cured sealing compounds according to claims 1 or 2.

8. Articles, shaped articles, or coatings containing cured sealing compounds according to claim 3.

9. Articles, shaped articles, or coatings containing cured sealing compounds according to claim 4.
